(19) United States
(12) Patent Application Publication
(10) Pub. No.: US 2002/0109595 A1
(43) Pub. Date: Aug. 15, 2002

(54) Personal alert device

(76) Inventors: Jerry Cairo, Chicago, IL (US); Patti Carrie, Chicago, IL (US)

Correspondence Address: Welsh & Katz, Ltd., Jon P. Christensen, 22nd Floor, 120 South Riverside Plaza, Chicago, IL, 60606, US

(21) Appl. No.: 09/780,798

(22) Filed: Feb. 9, 2001

(51) Int. Cl. G08B 23/00

(52) U.S. Cl. 340/573.1; 340/539

(57) ABSTRACT

A method and apparatus are provided for protecting the health and safety of an authorized user. The method includes the steps of monitoring a vital sign of the authorized user via a portable sensor attached to and carried by the authorized user and automatically calling for help using a radio frequency channel when the monitored vital sign exceeds a threshold value.

### FIELD OF THE INVENTION

The field of the invention relates to a personal monitoring devices and more particularly to devices for monitoring the vital signs of a user.

### BACKGROUND OF THE INVENTION

Devices for monitoring the vital signs of a person are generally known. Such devices may be attached to a person in a hospital or ambulance setting and may be used to monitor such parameters as heart rate, blood pressure or respiration.

In some cases, prior art monitoring devices have been provided with programmable threshold levels which cause an alarm to be sounded when the monitored vital sign falls below the threshold. To help alert hospital staff when an alarm occurs, such devices are typically hard-wired into a hospital monitoring system.

While such monitoring devices are effective, they do not provide flexibility of movement. Where a person is ambulatory, such devices cannot be used. Because of the importance of health and safety, a need exists for monitoring devices, which are more flexible.

### SUMMARY OF THE INVENTION

A method and apparatus are provided for protecting the health and safety of an authorized user. The method includes the steps of monitoring vital signs of the authorized user via a portable sensor attached to and carried by the authorized user and automatically calling for help over a radio frequency channel when the monitored vital sign exceeds a threshold value.

### BRIEF DESCRIPTION OF THE DRAWINGS

FIG. 1 is a perspective view of a personal alert device under an illustrated embodiment of the invention;

FIG. 2 is a block diagram of the device of FIG. 1; and

FIG. 3 is a block diagram of the device of FIG. 1 shown in a context of use.

### DETAILED DESCRIPTION OF AN ILLUSTRATED EMBODIMENT

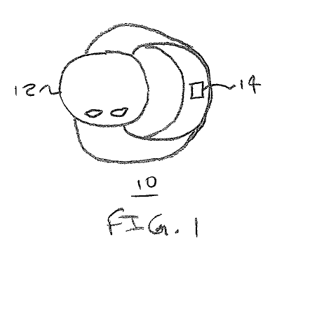

FIG. 1 depicts a perspective view of a personal alert device (PAD) 10 for monitoring a vital sign of a user and for calling for help when the vital sign exceeds certain threshold levels, shown generally under an illustrated embodiment of the invention. As used herein the term “vital sign” means any measured parameter of the human body related to preserving the life and/or safety of that body.

A vital sign could be a heart rate, blood pressure, skin resistance, electrocardiogram or electroencephalogram signals, body temperature, respiration or any other medically accepted parameter that may be used as an indication of the health and/or perceived safety of the user. The monitoring and reporting of vital signs may have great utility when worn by a person that may encounter acts of violence, danger, threats, illness, difficult or life-threatening situations and who may need assistance without the need for an explicit request for assistance. All monitoring may be stored in memory of the apparatus and be transmitted to the monitoring station and the user's history may be stored and can be referred to identify the user based upon stored history.

For example, the PAD 10 may be useful in providing timely assistance to injured police officers on patrol or for the armed forces in combat situations. Alternatively, night watchmen in factories or employees doing dangerous jobs in remote locations may benefit from the ability to secure help where necessary.

As shown in FIG. 1, one or more sensors 14 may be coupled to a monitoring and reporting unit 12. The PAD 10 may be structured as a wrist-worn device, but could be structured in any manner, which allows the sensor 14 to monitor one or more vital signs of the body. The PAD 10 may be structured in the form of one or more devices.

For example, the system 10 could be attached to a person via a waistband. Sensors 14 may be attached to a chest of the user with leads extending to the reporting unit or via wireless transmitters 12 for purposes of monitoring cardiac activity. An armband may act as a blood pressure sensor 14 which may be attached to the reporting unit 12 in a similar manner. A skin resistance sensor 14 may be used to detect adrenaline levels, thereby providing a convenient means of measuring perceived threats.

Under the illustrated embodiment, the PDA 10 functions under a set of records, some of which change over time and some of which do not change following activation. For example, monitored vital signs of a user may be averaged over a time period (e.g., one week, two weeks, etc.) to determine a norm for a user. A percentage adder (e.g., 10%) may be added to the norm to determine one or more threshold values that may be stored in a memory and used to active the PDA 10.

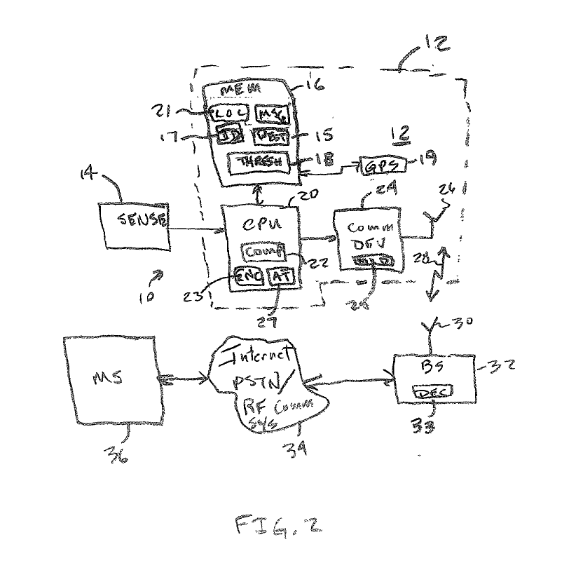

FIG. 2 is a block diagram of the PAD 10 shown in a context of use. As shown, a central processing unit (CPU) 20 continually monitors an output from the one or more sensors 14. As it reads the sensor 14, the CPU 20 may compare the reading from the sensor 14 with the one or more threshold values 18 stored in a memory 16. Where the reading of the sensor 14 exceeds the threshold 18, the CPU 20 may place a call for help to a monitoring station 36.

The call for help may take a number of different forms (e.g., land-based, satellite, wireless, etc.). For example, the communication device 24 may be structured as a cellular transmitter programmed to transmit a help request (message 28) to a cellular base station 32 over a control channel of the cellular communication system. Alternatively, the communication device 24 may be a wireless low-powered device intended to transmit the message 28 over a short range from a user (e.g., within his home) to a base station 32 (also possibly within the user's home). The base station 32 may then place a call to the monitoring station 36.

Alternatively, the PAD 10 may operate using a personal digital assistant (PDA) as a platform using any appropriate protocol (e.g., wireless application protocol (WAP), Bluetooth, etc.). The base station 32 may be a local interface to the Internet. The monitoring station 36 may be a destination on the Internet. Further, any combination of communication systems could be used.

In a factory setting, a number of base stations 32 may be provided. The base stations 32 may be distributed around a perimeter of the factory enclosure for detection of PAD signals.

In the case of a police officer, the communication device 24 may transmit the help message to a repeating transceiver 32 in a squad car, which may then transfer the request to a police station through a radio frequency (RF) communication system 34.

As a further alternative, the base station 34 may be located in any vehicle, whether a surface vehicle or airplane. The base stations 34 may also be distributed randomly (under either a stationary or mobile format) and programmed to respond to the PAD 12 of any user.

Where the base stations 34 are programmed for use by any user, an identifier of the user may be encrypted by an encoder 23 within the reporting unit 12. A decoder 33 either within the base station 32 or monitoring station 36 may decode the identifier of the user.

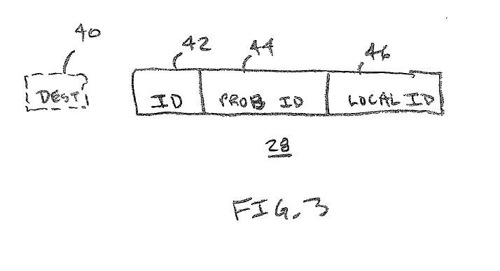

In order to place a call for help, the CPU 20 may compose and transfer a help message to a communication device 24. FIG. 3 depicts an example of a message 28 that may be composed by the CPU 20.

In the case where the communication device 24 is a cellular phone, the message 28 may be preceded by a destination telephone number 21 in a destination telephone number field 40. The CPU 20 may first retrieve the destination telephone number 17 from memory and transfer it to the communication device 24. To place the call, the communication device 24 may seize a channel and transfer the telephone number 40 to the base station 32. The base station 32 may set up a dedicated call connection between the communication device 24 and monitoring station 36. Upon detecting completion of the connection, the communication device 24 may couple a modem 25 to the connection and complete transfer of the message 28.

Included within the message 28 may be a first field 42 that may contain an identifier (ID) 17 of the PAD 10. A second field 44 may include an identifier of the vital sign. A third field 46 may include a location identifier 21 (address of the user).

In the case where the base station 32 is located in the home of the user, the destination telephone number 17 and location identifier 21 may be stored in the base station 32. Upon receipt of the message 28 by the base station 32, the base station 32 may seize a telephonic line and dial the monitoring station 36. When the monitoring station 36 answers, the base station 32 may transfer the message 28 to the monitoring station.

As an alternative to the message 28, the base station 32 may store a recorded audio message. Upon connecting to the monitoring station 36, the base station may play back the audio message requesting help and the desired location.

The monitoring station 36 may be any commercial or dedicated monitoring facility. Examples include fire and police departments, medical centers, high-value dispatch systems, private monitoring stations or any communication system charged with the safety and protection of personnel. Contact with the monitoring station 36 may be through telephonic or wireless contact channels.

As another alternative, the PAD 10 may include a global positioning system (GPS) sensor 19. The GPS 19 may periodically determine its location and store that location in the location memory 21. When a help request is transmitted, the message may include the location determined by the GPS 19.

In another illustrated embodiment, the PAD 10 may be programmed to detect tampering, such as transfer to an unauthorized user or removal from the authorized user's body. An biometric detector (e.g., an acoustic transducer) 27 may be provided within the PAD 10 which measures a bone structure or other biometrics of the user during initialization of the PAD 10 and permanently stores the readings as a biometric template in memory 16. The CPU 20 continually compares the measured structure (of a current user of the PAD 10) with the biometric template stored in memory 16. Where the measured structure does not match the stored template of the authorized user, the PAD 10 may automatically deactivate or transmits notification to the monitoring station 36. As used herein, the term “authorized user” means the user whose measured biometric structure substantially matches the biometric template stored in memory 16.

Under an alternate illustrated embodiment, the PAD 10 may be provided with an audio processing module. The audio processing module may use speech templates stored in memory to identify authorized users. Alternately, the audio processing may use speech recognition to recognize pleas for help or indications of threat or any other utterance made under stress.

Under another alternate embodiment, a number of devices 10 may be used by any particular user. Each PAD 10 may operate to detect and monitor a different vital sign. Further, one or more devices 10 may be equipped with a miniature video camera that may function to transmit images to the monitoring station 36 giving an operator of the station 36 the ability to view and evaluate the help needed.

Under another embodiment, the PAD 10 monitors for other devices 10 proximate the user. A receiver within the PAD 10 may monitor for frequencies used by other devices 10 or for a set of identifiers used by other devices 10. The ability to detect other PADs 10 may allow a dispatcher to tailor a response to the need where multiple requests for help are needed.

Further, using voice recognition or auxiliary pushbuttons on the PAD 10 and the biometric comparison, the device may be programmed for auxiliary functions. For example, the PAD 10 may be programmed to lock and unlock (open and close) doors for the authorized user.

Alternatively, an accounting system may be provided within the PAD 10 to provide charge authorizations for purchases by the transmission or authorization codes (e.g., credit card numbers, debit card numbers, etc.). Toll payments may be made with the PAD 10, but only where a current biometric reading matches the biometric template in memory. Vending machine purchases may be made. Based upon the biometric comparison, the seller has assurance that the sale was made to the authorized user of the PAD 10.

Alternately, the base stations 32 may provide tracking of the PAD 10. In an open environment (e.g., a factory), a number of base stations 32 may triangulate a transmitted signal to locate the user.

A specific embodiment of a method and apparatus for obtaining help for a user according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of protecting the health and safety of an authorized user comprising the steps of:
monitoring a vital sign of the authorized user via a portable sensor attached to and carried by the authorized user; and
automatically calling for help using a radio frequency channel when the monitored vital sign exceeds a threshold value.

2. The method of protecting the health and safety of the authorized user as in claim 1 wherein the step of monitoring the vital sign further comprises measuring a heart rate of the authorized user.

3. The method of protecting the health and safety of the authorized user as in claim 1 wherein the step of monitoring the vital sign further comprises measuring a blood pressure of the authorized user.

4. The method of protecting the health and safety of the authorized user as in claim 1 wherein the step of monitoring the vital sign further comprises measuring a galvanic skin resistance of the authorized user.

5. The method of protecting the health and safety of the authorized user as in claim 1 wherein the step of monitoring the vital sign further comprises measuring a body temperature of the authorized user.

6. The method of protecting the health and safety of the authorized user as in claim 1 wherein the step of monitoring and calling for help further comprises comparing the monitored vital sign with the threshold value.

7. The method of protecting the health and safety of the authorized user as in claim 1 wherein the step of calling for help further comprises transceiving a wireless message to a basestation.

8. The method of protecting the health and safety of the authorized user as in claim 7 wherein the step of transceiving the wireless message to the basestation further comprises encoding the message with an identifier of the monitored vital sign.

9. The method of protecting the health and safety of the authorized user as in claim 7 wherein the step of transceiving the wireless message to the basestation further comprises encoding the message with a magnitude of current and past vital signs the monitored vital sign.

10. The method of protecting the health and safety of the authorized user as in claim 7 wherein the step of transceiving the wireless message to the basestation further comprises encoding the message with an identifier of the authorized user.

11. The method of protecting the health and safety of the authorized user as in claim 7 wherein the step of transceiving the wireless message to the basestation further comprises selecting a control channel of a local cellular basestation for transmission of the message.

12. The method of protecting the health and safety of the authorized user as in claim 7 wherein the step of transceiving the wireless message to the basestation further comprises selecting a channel of a authorized user basestation.

13. The method of protecting the health and safety of the authorized user as in claim 1 wherein the step of calling for help further comprises dialing a telephone number of a remotely located monitoring station and playing back a prerecorded message.

14. An apparatus for protecting the health and safety of a user comprising:
means for monitoring a vital sign of the user via a portable sensor attached to and carried by the user; and
means for automatically calling for help when the vital sign exceeds a threshold value.

15. The apparatus for protecting the health and safety of the user as in claim 14 wherein the means for monitoring the vital sign further comprises means for measuring a heart rate of the user.

16. The apparatus for protecting the health and safety of the user as in claim 14 wherein the means for monitoring the vital sign further comprises means for measuring a blood pressure of the user.

17. The apparatus for protecting the health and safety of the user as in claim 14 wherein the means for monitoring the vital sign further comprises means for measuring a galvanic skin resistance of the user.

18. The apparatus for protecting the health and safety of the user as in claim 14 wherein the means for monitoring the vital sign further comprises means for measuring a body temperature of the user.

19. The apparatus for protecting the health and safety of the user as in claim 14 wherein the means for monitoring and calling for help further comprises means for comparing the monitored vital sign with the threshold value.

20. The apparatus for protecting the health and safety of the user as in claim 14 wherein the means for calling for help further comprises means for transceiving a wireless message to a basestation.

21. The apparatus for protecting the health and safety of the user as in claim 20 wherein the means for transceiving the wireless message to the basestation further comprises means for encoding the message with an identifier of the monitored vital sign.

22. The apparatus for protecting the health and safety of the user as in claim 20 wherein the means for transceiving the wireless message to the basestation further comprises means for encoding the message with a magnitude of the monitored vital sign.

23. The apparatus for protecting the health and safety of the user as in claim 20 wherein the means for transceiving the wireless message to the basestation further comprises means for encoding the message with an identifier of the user.

24. The apparatus for protecting the health and safety of the user as in claim 20 wherein the means for transceiving the wireless message to the basestation further comprises means for selecting a control channel of a local cellular basestation for transmission of the message.

25. The apparatus for protecting the health and safety of the user as in claim 20 wherein the means for transceiving the wireless message to the basestation further comprises means for selecting a channel of a user basestation.

26. The apparatus for protecting the health and safety of the user as in claim 14 wherein the means for calling for help further comprises means for dialing a telephone number of a remotely located monitoring station and playing back a prerecorded message.

27. An apparatus for protecting the health and safety of a user comprising:
a sensor adapted to monitor a vital sign of the user via a portable sensor attached to and carried by the user; and
a communications device adapted to automatically call for help when the vital sign exceeds a threshold value.

28. The apparatus for protecting the health and safety of the user as in claim 27 wherein the sensor further comprises a heart rate detector.

29. The apparatus for protecting the health and safety of the user as in claim 27 wherein the sensor further comprises a blood pressure detector.

30. The apparatus for protecting the health and safety of the user as in claim 27 wherein the sensor further comprises a resistance meter adapted to measure a galvanic skin resistance of the user.

31. The apparatus for protecting the health and safety of the user as in claim 27 wherein the sensor further comprises a thermometer adapted to measure a body temperature of the user.

32. The apparatus for protecting the health and safety of the user as in claim 27 further comprising a comparator adapted to compare the monitored vital sign with the threshold value.

33. The apparatus for protecting the health and safety of the user as in claim 27 wherein the communication device further comprises a cellular transceiver adapted to transceive a wireless message to a basestation.

34. The apparatus for protecting the health and safety of the user as in claim 27 wherein the communication device further comprises a user basestation.

35. The apparatus for protecting the health and safety of the user as in claim 34 wherein the user basestation further comprises a communication controller adapted to dial a telephone number of a remotely located monitoring station and play back a prerecorded message.

36. The method of protecting the health and safety of a user as in claim 1 further comprising calling for help when a biometric template of a current user is different than an authorized user.

37. The method of protecting the health and safety of the authorized user as in claim 1 further comprising transmitting a location of the user using a global positioning system.

38. The method of protecting the health and safety of the authorized user as in claim 1 further comprising determining the threshold based upon a historical average in memory for the user.

39. A method of protecting the health and safety of an authorized user comprising the steps of:
monitoring a vital sign of the authorized user via a portable sensor attached to and carried by the authorized user; and
automatically calling for help using a radio frequency channel when the monitored vital sign exceeds a threshold value.

40. The method of protecting the health and safety of the authorized user as in claim 39 wherein the step of monitoring the vital signs further comprises measuring a combination of all vitals to make a determination as to the welfare of the authorized user.

41. The method of protecting the health and safety of the authorized user as in claim 39 wherein the step of monitoring the vital sign further comprises measuring a body temperature of the authorized user.

42. The method of protecting the health and safety of the authorized user as in claim 39 wherein the step of monitoring and calling for help further comprises comparing all monitored vital signs with a respective threshold value.

43. The method of protecting the health and safety of the authorized user as in claim 39 wherein the step of calling for help further comprises transceiving a wireless message to a basestation without the user's participation.

44. The method of protecting the health and safety of the authorized user as in claim 39 wherein the step of calling for help further comprises dialing a telephonic number of a remotely located monitoring station and playing back a prerecorded message.

45. An apparatus for protecting the health and safety of a user comprising:
means for monitoring at least some vital signs of the user via portable sensors attached to and carried by the user; and
means for automatically calling for help when the vital signs exceed threshold values.

46. The apparatus for protecting the health and safety of the user as in claim 45 wherein the means for monitoring and calling for help further comprises means for comparing all the monitored vital signs with a respective threshold value.

47. The apparatus for protecting the health and safety of the user as in claim 45 wherein the means for calling for help further comprises means for transceiving wireless messages encoded with magnitude of vital signs and an identifier of the user.

48. An apparatus for protecting the creditability and safety of a user comprising:
sensors adapted to monitor at least some vital signs of the user via a portable sensors attached to and carried by the user; and a wireless communications device adapted to communicate with other devices if at least some of the vital signs exceed a threshold value.

49. The apparatus for protecting the creditability and safety of a user as in claim 48 further comprising monitoring at least some biometrics of a user and determining that the monitored biometric matches the biometric template of the authorized user and that payment can be made by transmission of authorizations for purchases.

50. The apparatus for protecting the creditability and safety of a user as in claim 48 further comprising turning off the wireless transceiver when a biometric template of a current user is different than an authorized user.

51. The apparatus of protecting the creditability and safety of the authorized user as in claim 48 further comprising transmitting authorization codes that will debit the users account at a point of purchase location only if at least some biometric vitals are identified as to the user records on file.

52. The method of protecting the creditability and safety of the authorized user as in claim 48 further comprising determining that the user is the authorized user by matching a history of vital signs to the set of records on file.

53. The method of protecting the creditability and safety of the authorized user as in claim 48 further comprising transmitting authorization encrypted codes to provide charge authorizations to a seller that will debit the user's account for a purchase at a location only if all biometric and vital signs match the user set of records on file.

54. The method of protecting the health and creditability of the authorized user as in claim 48 further comprising determining the threshold based upon a historical average for the user.

55. A method of protecting the health and safety of an authorized user comprising the steps of:
using voice recognition or auxiliary pushbuttons on the PAD 10 to identify and allow the authorized user to call for help,
having a stored recorded audio message; and
connecting to the monitoring station, the base station may play back the audio message requesting help and the desired location.

56. The method of protecting the health and safety of the authorized user further comprising transmitting the call for help to a monitoring station through the Internet.
